(19) United States
(12) Patent Application Publication
(10) Pub. No.: US 2007/0142692 A1
(43) Pub. Date: Jun. 21, 2007

(54) Method of refinishing a wall containing lead paint

(76) Inventors: Todd H. Hall, Sylvania, OH (US); Charles R. Weir, Westerville, OH (US)

Correspondence Address: OWENS CORNING, 2790 COLUMBUS ROAD, GRANVILLE, OH, 43023, US

(21) Appl. No.: 11/314,916

(22) Filed: Dec. 21, 2005

(51) Int. Cl. B09B 3/00

(52) U.S. Cl. 588/249; 427/1; 52/27; 156/1

(57) ABSTRACT

A method of refinishing a wall containing lead paint includes the steps of covering the wall with a series of barrier boards impermeable to lead dust, sealing joints between the barrier boards so as to prevent the passage of lead dust and installing finishing panels over the series of barrier boards. A lead abatement system is also provided including a series of barrier boards, joint tape and finishing panels.

### TECHNICAL FIELD

This invention relates to methods for controlling the health risks related to lead based paint on walls and ceilings.

### BACKGROUND OF THE INVENTION

Before the 1970s, many paints contained lead. As these lead containing paints age, they may chip or crumble into dust. It is now known that exposure to lead containing paint, dust or chips may cause serious health problems. More specifically, the lead in these paints is highly toxic. When ingested, the lead enters the bloodstream where it can inhibit the production of hemoglobin. The lead also locks onto essential enzymes in the brain and central nervous system to inactivate them. Children and pregnant women are particularly susceptible to lead poisoning. The symptoms of lead poisoning include but are not limited to abdominal pain, muscular weakness and fatigue, nervous system disorders, high blood pressure and in severe cases, death.

The present invention relates to a simple and economical method for sealing off a wall with lead paint from the living environment.

### SUMMARY OF THE INVENTION

In accordance with the purposes of the present invention as described herein, an improved method is provided for refinishing a wall containing lead paint. That method includes the steps of covering the wall containing lead paint with a series of barrier boards impermeable to lead dust, sealing joints between the barrier boards so as to prevent passage of lead dust and installing finishing panels over the series of barrier boards. The barrier boards used are characterized by an air resistance permeability of less than about 0.02 L/(s-m²), more typically less than about 0.001 L/(s-m²) and most typically less than about 0.00010 L/(s-m²) at 75 Pa. The method may further include using barrier boards having two polyethylene film layers sandwiching a core of polystyrene having a closed cell structure of at least about 95%.

More specifically describing the method, the sealing includes lapping the joints between the series of barrier boards with an adhesive tape made from a material impervious to lead dust. Further the method may include providing a lead paint warning label on an outer surface of at least one board of the series of barrier boards. The barrier boards may be fastened to the wall with mechanical fasteners, adhesive or even a combination of the two.

For certain applications it may be desirable to provide a fire protective film media such as a filled glass mat layer between the series of barrier boards and the finishing panels to protect the barrier boards for combustibility. The method may include using a clay filled glass mat for the glass mat layer. Preferably the edges of the individual glass mats are overlapped so as to avoid open joints there between. When the optional glass mat layer is used, the lead paint warning label is provided on the face of the layer directed toward the interior of the room.

The step of installing the finishing panels includes fastening a lineal component to the wall, positioning finishing panels in the lineal component and installing any necessary trim around doors and windows and along the floor and ceiling. The finishing panels are made from fibrous insulative materials such as glass fibers, polymeric fibers, or a mixture of glass and polymeric fibers. The board may also be covered with a decorative fabric.

In addition the method may be extended to include the covering of a ceiling adjacent the wall with a series of barrier boards impermeable to lead dust. A lead paint warning label may be provided on at least one board of the series of boards covering the ceiling. This is followed by the installing of tongue and groove ceiling tiles directly to the series of barrier boards covering the ceiling or installing a suspended ceiling under the series of barrier boards covering the ceiling.

In accordance with an additional aspect of the present invention, a lead paint abatement system is provided for covering a wall including lead paint. That system includes a series of barrier boards constructed from a material impervious to lead dust, a tape, also impervious to lead dust, for sealing joints between the series of barrier boards and a series of finishing panels for covering the barrier boards. Still further the system includes a lead paint warning label that is provided on at least one of the barrier boards. In addition the system includes an optional clay filled glass mat for sandwiching between the barrier boards and the finishing boards. When the glass mat is utilized the lead paint warning label is provided on the face of at least one of the clay filled glass mats.

In the following description there is shown and described a preferred embodiment of this invention, simply by way of illustration of one of the modes best suited to carry out the invention. As it will be realized, the invention is capable of other different embodiments and its several details are capable of modification in various, obvious aspects all without departing from the invention. Accordingly, the drawings and descriptions will be regarded as illustrative in nature and not as restrictive.

### BRIEF DESCRIPTION OF THE DRAWINGS

The accompanying drawings incorporated in and forming a part of this specification, illustrates several aspects of the present invention and together with the description serves to explain certain principles of the invention. In the drawings:

FIG. 1 is a partially cutaway perspective view for illustrating a first embodiment of the method of the present invention for refinishing a wall containing lead paint;

FIG. 2 is an end elevational view showing a wall and ceiling after completion of the first embodiment of the present method; and

FIG. 3 is an end elevational view showing a wall and ceiling after completion of a second embodiment of the present method.

Reference will now be made in detail to the present preferred embodiments of the invention, examples of which are illustrated in the accompanying drawings.

### DETAILED DESCRIPTION OF THE INVENTION

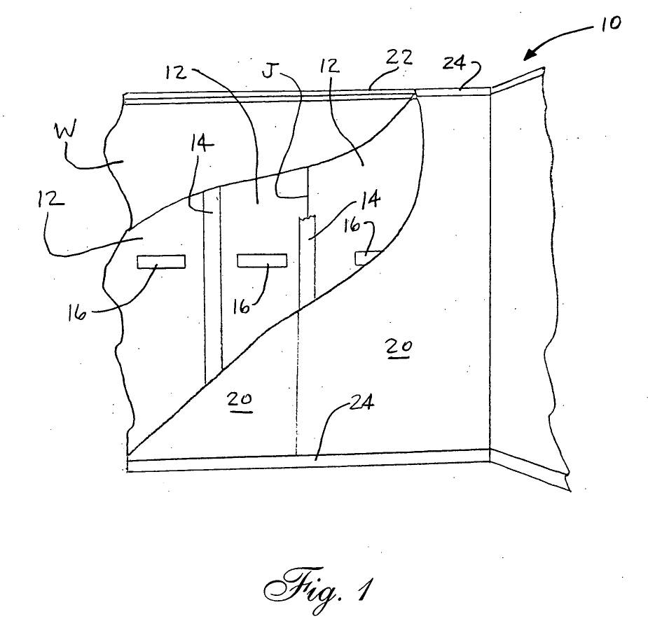

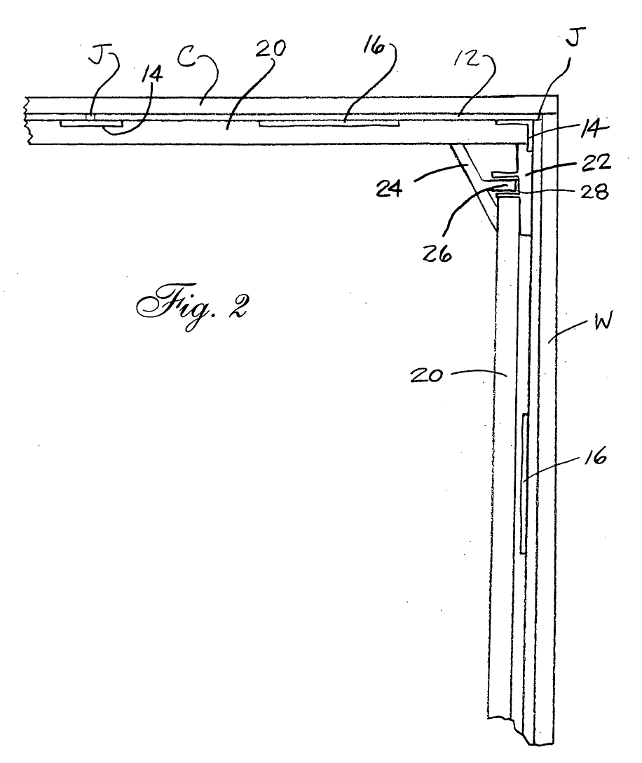

Reference is now made to FIGS. 1 and 2 illustrating the first embodiment of the lead paint abatement system 10 of the present invention used to cover a wall W and/or ceiling C covered with a layer of lead paint P. The system includes a series of barrier boards 12 that are impermeable to lead dust. The barrier boards 12 are made from a material with an air resistance permeability of less than about 0.02 L/(s-m²), still more typically less than about 0.001 L/(s-m²) and most typically less than about 0.00010 L/(s-m²) at 75 Pa when tested by the ASTM E 2178-01 procedure. Sheets of FOAMULAR FanFold, 150, and FOAMULAR 250 as manufactured by Owens Coming may be used for the barrier boards 12. The FOAMULAR® product comprises two polyethylene film layers sandwiching a core of polystyrene having a closed cell structure of at least about 95%.

The joints J between the barrier boards 12 are sealed so as to prevent the passage of lead dust. This may be accomplished by lapping the joints with an adhesive tape 14 made from a material impervious to lead dust. AiResist® air barrier tape available from Owens Corning may be utilized for this purpose. The product consists of a rubber modified asphalt adhesive layer and a cross-laminated polyethylene film. Such a tape provides an air resistance permeability of lower than about 0.02 L/(s-m²) at 75 Pa when tested in accordance with the ASTM E 2178-01 procedure.

Once the wall W and/or ceiling C is completely covered with barrier boards 12 and all the joints J between the barrier boards are sealed with tape 14, the layer of lead paint on the wall W is effectively sealed from the living environment in the room. Of course, it is important to insure that the barrier boards 12 are securely attached to the wall W. Toward this end the barrier boards 12 may be secured to the wall W using any appropriate mechanical fastener and/or any appropriate adhesive. Mechanical fasteners useful in securing the barrier boards 12 to the wall W include staples, nails and screws or the like. Adhesives useful for securing the barrier boards 12 to the wall W include Liquid Nails, Hot Melt Glue or the like.

In accordance with an additional aspect of the present invention a lead paint warning label 16 may be provided on the outer surface (the surface away from the wall) of at least one and preferably all the barrier boards 12 so as to inform anyone that a lead paint hazard exists behind the barrier boards 12.

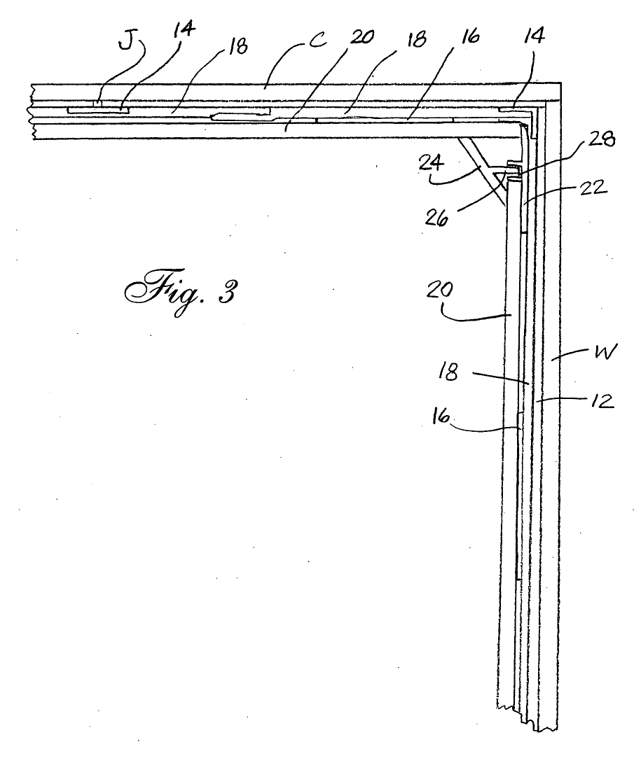

For certain applications and, particularly, where building codes or consumers desire additional fire protection, an optional glass mat layer 18 is provided over the barrier boards 12 (see second embodiment illustrated in FIG. 3). Typically a clay filled glass mat such as VL3550 glass mat available from Owens Coming is used for the glass mat layer 18. This material provides excellent fire resistance properties. Such a glass mat is very thin, on the order of less than about 0.15875 cm thick. In order to insure optimum fire resistance properties the edges of the individual glass mats making up the glass mat layer 18 are overlapped so as to avoid open joints therebetween. The glass mats of the layer 18 are securely held in place by appropriate fasteners and/or adhesives as described above with respect to the barrier boards 12. Of course where the optional glass mat layer 18 is installed, the lead paint warning labels 16 are placed on the outer surface of the glass mat layer 18 facing toward the interior of the room.

In either illustrated embodiment, the lead paint abatement system 10 also includes an outer aesthetic covering of finishing panels 20 constructed from glass fibers, polymeric fibers and mixtures thereof. The finishing panels 20 may comprise a fiberglass and binder resin product of about five pounds per cubic foot density and nominal one-inch thickness. Such a product may include, for example, about 86% fiberglass and about 14% urea formaldehyde resin. The fiberglass finishing panels 20 may also be covered in a decorative fabric such as a polyolefin fabric. As described in detail below, the panels and mounting accessories currently commercially marketed by Owens Corning under the trademark Basement Finishing System may be used in the present method.

Specifically, mechanical fasteners such as staples, nails or screws are utilized to secure lineal components 22 to the wall W along the ceiling C and floor F. The finishing panels 20 are then cut to size and positioned in the lineal components 22. The panels 20 are secured in the lineal components 22 by screws or other semipermanent fastening means so that the finishing panels 20 may be removed if desired for cleaning or replacement. The preferred method of mounting panels into the lineals is the use of the snap-in-place trim components as utilized in the Owens Corning Basement Finishing System and Room Finishing system products to eliminate the need to use fasteners or adhesive to mount the panels in place and to make these panels removable for whatever purpose that may be required. After positioning the finishing panels 20 in the lineal components 22, one installs any necessary trim 24 around the doors and windows and along the floor and ceiling. More specifically, the trim 24 includes a tongue 26 that snaps into the cooperating groove 28 provided on the lineal components 22. Thus, the trim 24 is cut to proper length and snapped in place in the lineal components 22 to complete the aesthetically pleasing wall covering around doors and windows and along the floor and ceiling.

Where the system 10 is also utilized to abate a lead paint risk with respect to the ceiling, the ceiling is covered with barrier boards 12 and the joints J between those boards are sealed with tape 14 in the same manner as described above for the walls W. A similar warning label 16 may be provided on at least one but preferably all of the barrier boards 12 just as described above with respect to the covering of the walls W. Next, the optional glass mat layer 18 may be provided over the barrier boards 12 on the ceiling C if desired (if present, the warning label 16 is provided on the face of the layer 18 toward the interior of the room). Typically the glass mat layer 18 is stapled or adhered in place utilizing an adhesive. Next, decorative tongue and groove ceiling tiles 30 may be applied directly to the barrier boards or glass mat layer covering the ceiling. Alternatively, a suspended ceiling may be installed under the barrier boards 12 and optional glass mat layer 18 if present. Obviously the finishing panels 20 covering the wall W are cut to length so as to properly meet the ceiling tiles 30 or suspended ceiling after its installation.

The foregoing description of a preferred embodiment of the present invention has been presented for purposes of illustration and description. It is not intended to be exhaustive or to limit the invention to the precise form disclosed. Obvious modifications or variations are possible in light of the above teachings.

The embodiment was chosen and described to provide the best illustration of the principles of the invention and its practical application to thereby enable one of ordinary skill in the art to utilize the invention in various embodiments and with various modifications as are suited to the particular use contemplated. All such modifications and variations are within the scope of the invention as determined by the appended claims when interpreted in accordance with the breadth to which they are fairly, legally and equitably entitled. The drawings and preferred embodiments do not and are not intended to limit the ordinary meaning of the claims and their fair and broad interpretation in any way.

What is claimed:

1. A method of refinishing a wall containing lead paint, comprising:
covering said wall containing lead paint with a series of barrier boards impermeable to lead dust;
sealing joints between said barrier boards so as to prevent passage of lead dust; and
installing finishing panels over said series of barrier boards.

2. The method of claim 1, including using barrier boards with an air resistance permeability of less than about 0.02 L/(s-m²) at 75 Pa.

3. The method of claim 1, including using barrier boards with an air resistance permeability of less than about 0.001 L/(s-m²) at 75 Pa.

4. The method of claim 1, including using barrier boards with an air resistance permeability of less than about 0.00010 L/(s-m²) at 75 Pa.

5. The method of claim 1, including using barrier boards having two polyethylene film layers sandwiching a core of polystyrene having a closed cell structure of at least about 95%.

6. The method of claim 1, wherein said sealing includes lapping said joints between said series of barrier boards with an adhesive tape made from a material impervious to lead dust.

7. The method of claim 1, including providing a lead paint warning label on an outer surface of at least one board of said series of barrier boards.

8. The method of claim 1, further including fastening said series of barrier boards to said wall with mechanical fasteners.

9. The method of claim 1, further including fastening said series of barrier boards to said wall with an adhesive.

10. The method of claim 1, further including providing a glass mat layer between said series of barrier boards and said finishing panels.

11. The method of claim 10, including using a clay filled glass mat for said glass mat layer.

12. The method of claim 11, including overlapping edges of individual glass mats so as to avoid open joints therebetween.

13. The method of claim 12 including providing a lead paint warning label on an outer surface of said glass mat layer.

14. The method of claim 1, wherein said installing step includes:
fastening a lineal component to said wall;
positioning finishing panels in said lineal component;
installing any necessary trim around doors and windows and along floor and ceiling.

15. The method of claim 14, including using finishing panels made from a material selected from a group consisting of glass fibers, polymeric fibers and mixtures thereof.

16. The method of claim 14, including using finishing panels covered with a decorative fabric.

17. The method of claim 1, further including covering a ceiling adjacent said wall with a series of barrier boards impermeable to lead dust.

18. The method of claim 17, further including providing a lead paint warning label on at least one board of said series of boards covering said ceiling.

19. The method of claim 18, including installing tongue and groove ceiling tiles directly to said series of barrier boards covering said ceiling.

20. The method of claim 19, including installing a suspended ceiling under said series of barrier boards covering said ceiling.

21. A lead paint abatement system for covering a wall including lead paint, comprising:
a series of barrier boards constructed from a material impervious to lead dust;
a tape, impervious to lead dust, for sealing joints between said series of barrier boards; and
a series of finishing panels for covering said barrier boards.

22. The system of claim 21 including a lead paint warning label on at least one of said barrier boards.

23. The system of claim 21, further including a clay filled glass mat for sandwiching between said barrier boards and said finishing boards.

24. The system of claim 23, including a lead paint warning label on a face of said clay filled glass mat.
